(19) United States
(12) Patent Application Publication
(10) Pub. No.: US 2024/0191440 A1
(43) Pub. Date: Jun. 13, 2024

(54) SOIL PROCESSING ROLLER FOR A SOIL PROCESSING MACHINE

(71) Applicant: HAMM AG, Tirschenreuth (DE)

(72) Inventor: Stefan BÄUML, Tirschenreuth (DE)

(21) Appl. No.: 18/529,293

(22) Filed: Dec. 5, 2023

(30) Foreign Application Priority Data
Dec. 8, 2022 (DE) DE102022132599.7

(51) Int. Cl. E01C 19/26; E01C 19/23

(52) U.S. Cl. CPC E01C 19/266; E01C 19/236

(57) ABSTRACT

A soil processing roller for a soil processing machine, in particular a soil compactor, comprises a roller shell (24) which is elongated in the direction of a roller axis of rotation (W) and surrounds the roller axis of rotation (W), two disk-like support elements (28, 30) arranged at a distance from one another in the direction of the roller axis of rotation (W) and connected to an inner side (26) of the roller shell (24), and a circumferential wall (32) extending in the direction of the roller axis of rotation (W) between the support elements (28, 30) and adjoining the same, wherein an inner surface (34) of the circumferential wall (32) together with the support elements (28, 30) delimits a lubricant receiving volume (36), wherein in at least one of the support elements (28, 30) at least one lubricant drain opening (56) is provided, which is open to the lubricant receiving volume (36), wherein at least one lubricant collecting volume (58) is formed in the lubricant receiving volume (36), wherein the at least one lubricant collecting volume (58) can be emptied via a lubricant drain opening (56) that is open to the same. In order to provide the lubricant collecting volume (58), the inner surface (34) of the circumferential wall (32) has a radial distance (R) from the roller axis of rotation (W) that increases in the direction of the roller axis of rotation (W) towards the lubricant drain opening (56) which is open to the at least one lubricant collecting volume (58),

The present invention relates to a soil processing roller for a soil processing machine, in particular a soil compactor, comprising a roller shell which is elongated in the direction of a roller axis of rotation and surrounds the roller axis of rotation, two disk-like support elements arranged at a distance from one another in the direction of the roller axis of rotation and connected to an inside of the roller shell, and a circumferential wall extending in the direction of the roller axis of rotation between the support elements and adjoining the same, wherein an inner surface of the circumferential wall together with the support elements delimits a lubricant receiving volume, wherein in at least one of the support elements at least one lubricant drain opening is provided, which is open to the lubricant receiving volume, wherein at least one lubricant collecting volume is formed in the lubricant receiving volume, wherein the at least one lubricant collecting volume can be emptied via a lubricant drain opening that is open to the same.

Such a soil processing roller is known from JP 5745457 B2. In this known soil processing roller, the two disk-like support elements and the circumferential wall extending between them and adjoining them are provided in one piece as a cast component. In order to achieve a uniform mass distribution in the direction of the roller axis of rotation, the two support elements are dimensioned differently from one another. On the inner surface of the circumferential wall, rib-like elevations are provided at a circumferential distance from one another in the direction of the roller axis of rotation, which elevations have a projection height over the inner surface that decreases in the direction of the roller axis of rotation in a radially inward direction.

In one of the disk-like support elements, drain openings are provided, which are diametrically opposite one another with respect to the roller axis of rotation, through which openings liquid lubricant contained in the lubricant receiving volume can be drained. To drain lubricant, one of the drain openings can be positioned in a lower region in a height direction, for example directly below the roller axis of rotation in the height direction. Under the influence of gravity, the lubricant that does not completely fill the lubricant receiving volume will accumulate in a lower region of the lubricant receiving volume, which in this state provides a lubricant collecting volume to which the lubricant drain opening, which is then positioned at the bottom in the height direction, is open.

It is the object of the present invention to design such a soil processing roller in such a way that better emptying of the lubricant receiving volume is achieved.

According to the invention, this object is achieved by a soil processing roller for a soil processing machine, in particular a soil compactor, comprising a roller shell which is elongated in the direction of a roller axis of rotation and surrounds the roller axis of rotation, two disk-like support elements arranged at a distance from one another in the direction of the roller axis of rotation and connected to an inner side of the roller shell, and a circumferential wall extending in the direction of the roller axis of rotation between the support elements and adjoining the same, wherein an inner surface of the circumferential wall together with the support elements delimits a lubricant receiving volume, wherein in at least one of the support elements at least one lubricant drain opening is provided, which is open to the lubricant receiving volume, wherein at least one lubricant collecting volume is formed in the lubricant receiving volume, wherein the at least one lubricant collecting volume can be emptied via a lubricant drain opening that is open to the same.

The soil processing roller is characterized in that, to provide the lubricant collecting volume:
the inner surface of the circumferential wall has a radial distance from the roller axis of rotation that increases in the direction of the roller axis of rotation to the lubricant drain opening which is open to the at least one lubricant collecting volume, and/or
the inner surface of the circumferential wall has a radial distance from the roller axis of rotation that increases in the circumferential direction around the roller axis of rotation to the lubricant drain opening which is open to the at least one lubricant collecting volume.

By providing at least one volume region of the lubricant receiving volume that is effective as a lubricant collecting volume when lubricant is drained from the lubricant receiving volume with the variation according to the invention of the radial distance of the inner surface of the circumferential wall, the lubricant is increasingly directed towards the lubricant drain opening used or open for draining when draining from the lubricant receiving volume or is increasingly accumulated in a region of the lubricant receiving volume close to this lubricant drain opening. On the one hand, this has the consequence that contaminants contained in the lubricant increasingly accumulate in a region near the lubricant drain opening used for draining and are therefore correspondingly increasingly discharged from the lubricant receiving volume with the lubricant drained via the lubricant drain opening. On the other hand, this reduces the volume fraction of the lubricant receiving volume from which lubricant cannot flow out even when the lubricant drain opening is open.

When designing the inner surface of the circumferential wall with an increasing radial distance from the roller axis of rotation in the direction of the roller axis of rotation to the lubricant drain opening open to the at least one lubricant collecting volume, the inner surface of the circumferential wall can be essentially rotationally symmetrical with respect to the roller axis of rotation, in particular to achieve a uniform distribution of mass in the circumferential direction, at least in the axial region of the lubricant collecting volume. Advantageously, it is provided that the inner surface of the circumferential wall is essentially rotationally symmetrical over the entire axial extension region of the circumferential wall.

For easy manufacturability of the soil processing roller, when the inner surface of the circumferential wall is designed with the radial distance to the roller axis of rotation increasing in the direction of the roller axis of rotation towards the lubricant drain opening open to the at least one lubricant collecting volume, the radial distance in the direction of the roller axis of rotation can increase essentially constantly. In particular, if the inner surface is also designed to be rotationally symmetrical, this can lead to a substantially conical or frustoconical geometry of the inner surface.

When designing the inner surface of the circumferential wall with an increasing radial distance from the roller axis of rotation in the direction of the roller axis of rotation to the lubricant drain opening open to the at least one lubricant collecting volume, the inner surface of the circumferential wall can be essentially cylindrical at least in the axial region of the lubricant collecting volume. This also contributes to the easy production of such a soil processing roller. It should be noted that such a cylindrical geometry of the inner surface of the circumferential wall means that it has the same radial distance from the roller axis of rotation in the same circumferential regions in all axial regions comprised by the cylindrical geometry. Such a cylindrical geometry can therefore be provided, for example, with a circular cross-sectional contour, a polygonal cross-sectional contour, an elliptical or oval cross-sectional contour or the like.

Advantageously, it is provided that the inner surface of the circumferential wall is essentially cylindrical over the entire axial extension region of the circumferential wall.

In an embodiment of the inner surface of the circumferential wall with the a radial distance to the roller axis of rotation increasing toward the lubricant drain opening open to the at least one lubricant collecting volume in the circumferential direction around the roller axis of rotation, the inner surface of the circumferential wall can, for example, have a polygonal cross-sectional contour at least in the axial region of the lubricant collecting volume, wherein at least a part of the at least one lubricant collecting volume is formed in s corner region of the polygonal cross-sectional contour. In such a polygonal cross-sectional contour, the radial distance from the roller axis of rotation increases for each corner region, so that when such a corner region is positioned in a height direction below, for example directly below the roller axis of rotation, the lubricant contained in the lubricant receiving volume can increasingly accumulate increases in the corner region of the cross-sectional geometry of the inner circumferential wall, which then acts as at least a part of the lubricant collecting volume and can flow out via this volume region and the lubricant drain opening that is open towards it.

In an alternative embodiment of the soil processing roller, it can be provided that when the inner surface of the circumferential wall is designed with a radial distance to the roller axis of rotation increasing in the circumferential direction around the roller axis of rotation towards the lubricant drain opening open to the at least one lubricant collecting volume, the inner surface of the circumferential wall has a cross-sectional contour at least in the axial region of the lubricant collecting volume with a substantially constant radial distance from the roller axis of rotation in a first circumferential extension region and has, in a second circumferential extension region adjoining the first circumferential extension region in both circumferential directions up to a distance apex, a preferably continuously increasing radial distance from the roller axis of rotation, wherein at least a part of the at least one lubricant collecting volume is formed in the region of the distance apex. Due to the provision of the first circumferential extension region with a substantially constant radius and a radius variation only in the second circumferential extension region, an almost uniform mass distribution in the circumferential direction is supported.

In a further embodiment variant, when the inner surface of the circumferential wall is designed with a radial distance to the roller axis of rotation increasing in the circumferential direction around the roller axis of rotation towards the lubricant drain opening open to the at least one lubricant collecting volume, the inner surface of the circumferential wall can have, at least in the axial region of the lubricant collecting volume, a cross-sectional contour with, starting from a minimum distance, in both directions to a distance apex, a preferably continuously increasing radial distance from the roller axis of rotation, wherein at least a part of the at least one lubricant collecting volume is formed in the region of the distance apex.

In particular, if in such a configuration the minimum distance is essentially diametrically opposite the distance apex with respect to the roller axis of rotation, a substantially teardrop-shaped cross-sectional contour of the inner surface can be achieved, which allows the defined accumulation of lubricant or contaminants contained therein in the lubricant collecting volume, which is positioned below in the height direction when carrying out a draining process.

Moreover, in order to provide at least part of such a lubricant collecting volume, when the inner surface of the circumferential wall is designed with a radial distance to the roller axis of rotation increasing in the circumferential direction around the roller axis of rotation towards the lubricant drain opening open to the at least one lubricant collecting volume, the inner surface of the circumferential wall can have a step-wise radial widening at least in the axial region of the lubricant collecting volume.

In order to be able to construct the soil processing roller with formed sheet metal components for easy production, it is proposed that at least one support element having at least one lubricant drain opening, preferably each of the two support elements, is connected to the circumferential wall by a weld that runs around the roller axis of rotation, preferably without interruption, in the circumferential direction. On the one hand, this ensures that these components are firmly connected. On the other hand, the welding also ensures a tight seal of the lubricant receiving volume.

For reasons of stability, it may be necessary or advantageous to form the weld at least on a radial inner side of the circumferential wall. In order to avoid mutual interference of the welding with a lubricant drain opening, the inner surface of the circumferential wall in the region of the at least one lubricant drain opening can lie radially outside the at least one lubricant drain opening and have a radial distance from the lubricant drain opening. The height of this step can then correspond at least to the radial extent of the weld formed on the inside of the circumferential wall, so that the provision or introduction of the lubricant drain opening does not affect the structural strength of the weld.

In particular, if the soil processing roller is to be used to compact ground, an unbalance arrangement with at least one unbalance mass rotatable about an unbalance axis of rotation can be arranged in the lubricant receiving volume.

The at least one unbalance mass can be arranged on an unbalance shaft which is rotatably mounted in both axial end regions via bearing arrangements with respect to the support elements, so that the bearing points are open to the lubricant receiving volume and bearings provided there, in particular rolling element bearings, can be lubricated and cooled by the lubricant contained in the lubricant receiving volume.

The invention furthermore relates to a soil processing machine, in particular a soil compactor, comprising at least one soil processing roller constructed according to the invention.

The present invention is described in detail below with reference to the attached figures. In particular:

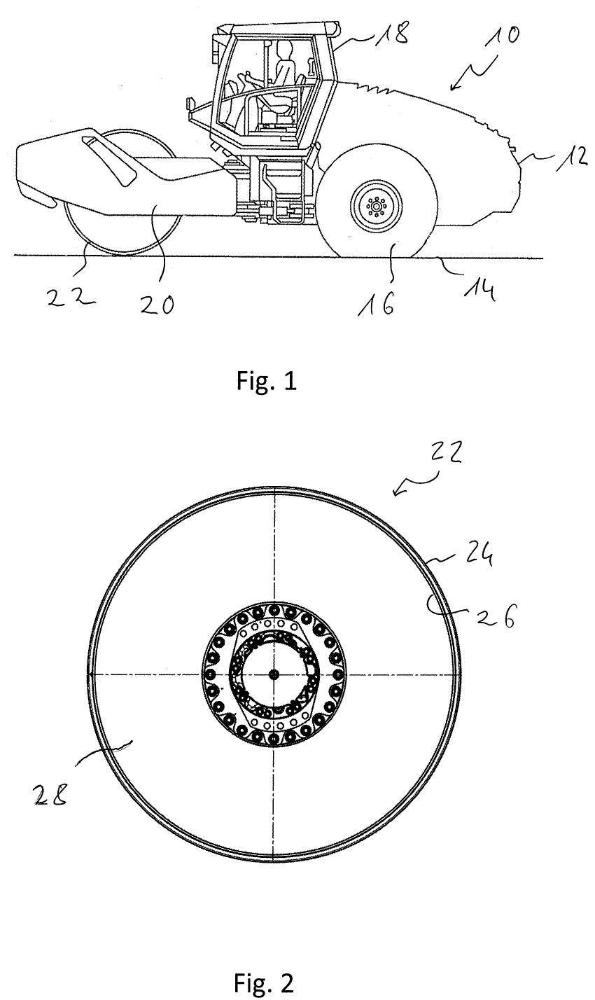

FIG. 1 shows a side view of a soil processing machine designed as a soil compactor;

FIG. 2 shows an axial view of a soil processing roller of the soil compactor of FIG. 1;

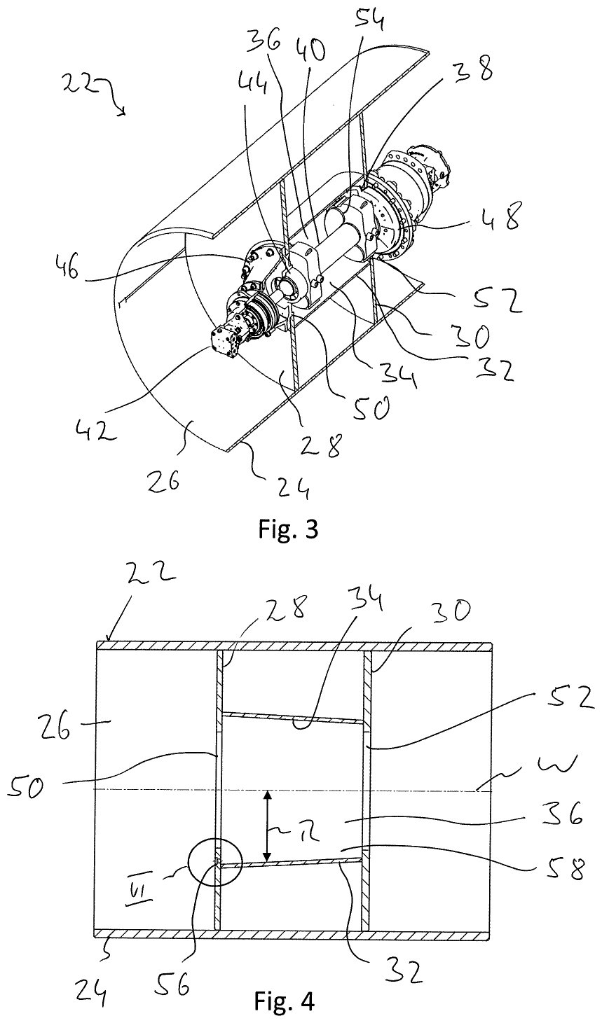

FIG. 3 shows a perspective longitudinal sectional view of the soil processing roller shown in FIG. 2;

FIG. 4 shows a longitudinal sectional view of a roller shell of a soil processing roller composed of two disk-like support elements and a circumferential wall extending therebetween;

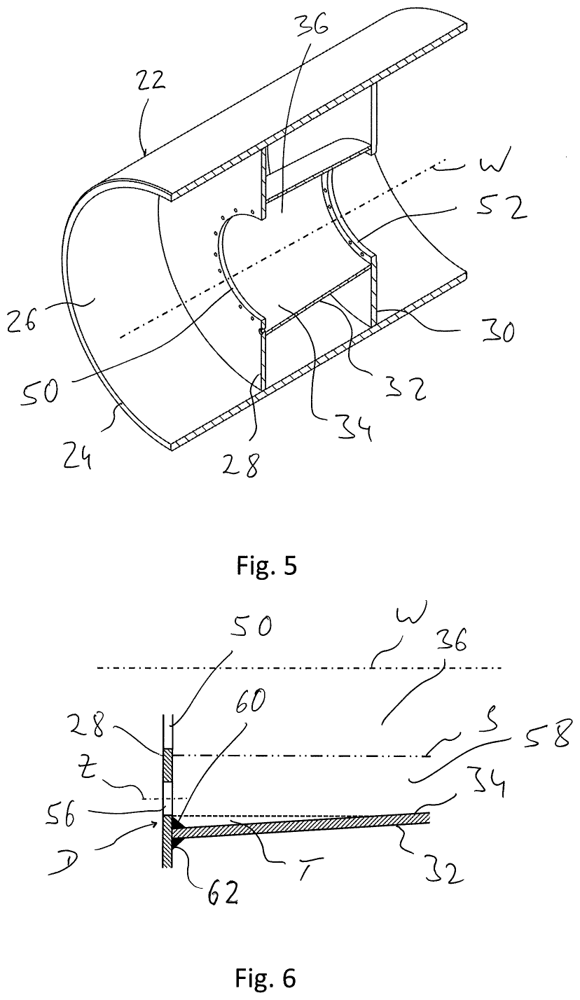

FIG. 5 shows the arrangement shown in FIG. 4 in a perspective longitudinal section view;

FIG. 6 shows a detailed view of the arrangement shown in FIGS. 4 and 5 in region VI in FIG. 4;

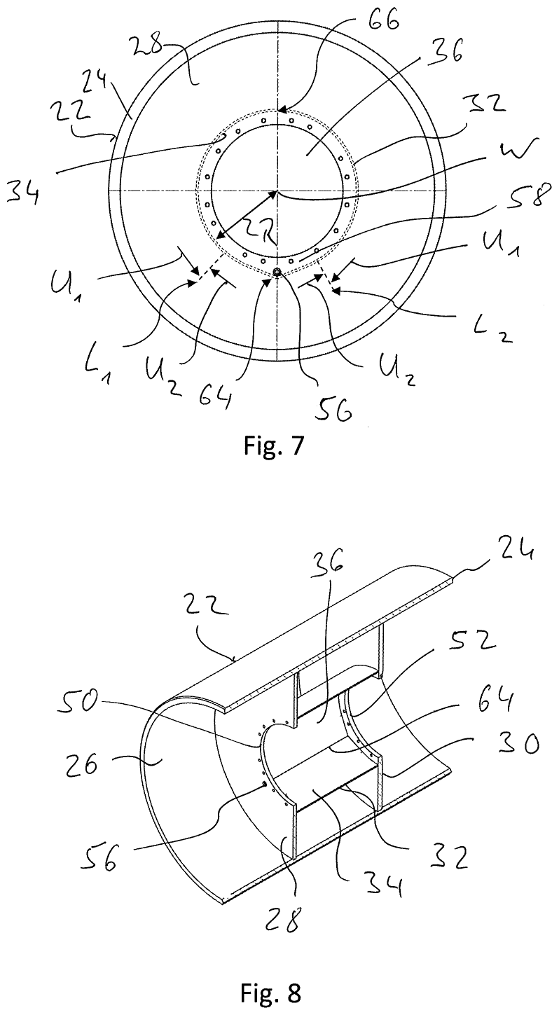

FIG. 7 shows an axial view of an alternative embodiment of a soil processing roller;

FIG. 8 shows the soil processing roller of FIG. 7 in a perspective longitudinal section;

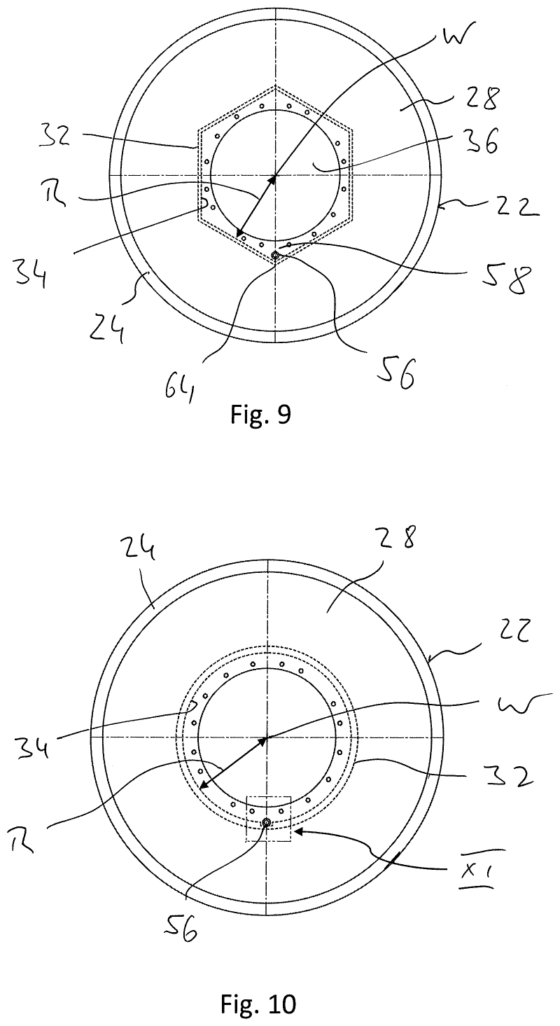

FIG. 9 shows a view corresponding to FIG. 7 of an further alternative embodiment of a soil processing roller;

FIG. 10 shows a view corresponding to FIG. 7 of a further alternative embodiment of a soil processing roller;

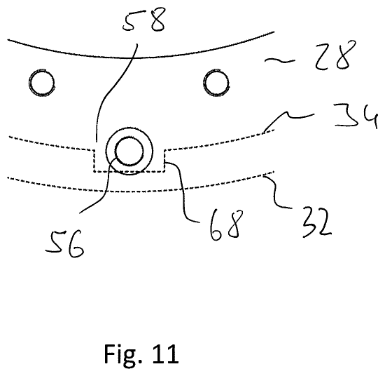

FIG. 11 shows enlarged detail XI of FIG. 10.

In FIG. 1, a soil processing machine designed as a soil compactor is generally designated by 10. This soil processing machine 10 comprises a rear carriage 12 with a drive unit provided thereon and drive wheels 16 which can be driven by the drive unit for moving the soil processing machine 10 forward on a ground surface 14 to be processed. On the rear carriage 12 there is also a control station 18 for an operator operating the soil processing machine 10.

A frame-like front carriage 20 is connected in an articulated manner to the rear carriage 12. On the front carriage 20, a soil processing roller 22 is rotatably supported about a roller axis of rotation which is perpendicular to the drawing plane of FIG. 1.

The basic structure of such a soil processing roller 22 can be seen in FIGS. 2 and 3. The soil processing roller 22 comprises a roller shell 24 which is cylindrical with respect to the roller axis of rotation. On an inner side 26 of the roller shell 24, two disk-like support elements 28, 30, also generally referred to as rondels, are firmly connected by welding at an axial distance from one another. A tubular circumferential wall 32 extends axially between the two support elements 28, 30 and is connected to the support elements 28, 30 in its two axial end regions by welding. An inner surface 34 of the circumferential wall 32, together with the support elements 28, 30, delimits a lubricant receiving volume 36, which is partially filled with a liquid lubricant, for example lubricating oil.

An unbalance arrangement, generally designated 38, is arranged in the lubricant receiving volume. The unbalance arrangement 38 comprises an unbalance shaft 40, which in the example shown can be driven by an unbalance drive motor 42 for rotation about an unbalance axis of rotation, for example the roller axis of rotation. In its two axial end regions, the unbalance shaft 40 is rotatably mounted on support units 46, 48 via bearings 44. The support units 46, 48 are inserted into central openings 50, 52 formed in the support elements 28, 30 and fixed to the support elements 28, 30 by screwing, so that via the bearings 44 and the support units 46, 48 the unbalance shaft 40 is supported and rotatably mounted relative to the support elements 28, 30. At least one unbalance mass 54 is arranged on the unbalance shaft 40 and has a center of mass eccentric relative to the unbalance axis of rotation. By rotating the unbalance shaft 40 and thus the at least one unbalance mass 54, a force or acceleration oriented perpendicularly to the roller axis of rotation is exerted on the soil processing roller 22, so that it is set into a vibratory movement for improved compaction operation.

It should be noted that the basic structure of a soil processing machine 10 or a soil processing roller 22 of the same was described above with reference to FIGS. 1 to 3. The design of such a soil processing machine 10 or soil processing roller 22 can deviate from the previously described configuration in various aspects. For example, such a soil processing roller could also be provided on the rear carriage 12. The unbalance arrangement 38 can have several unbalance shafts with unbalance masses provided thereon which are eccentric to the roller axis of rotation and arranged at a circumferential distance from one another.

FIGS. 4 to 6 show in more detail the soil processing roller 22 or roller shell 24 with the disk-like support elements 28, 30 connected to the inner side 26 of the same and the circumferential wall 32 extending between them in the direction of the roller axis of rotation W. In the support element 28 on the left in FIG. 4, a lubricant drain opening 56 is provided in a circumferential region. By means of a closing element, not shown in the figures and which can be screwed into the lubricant drain opening 56, for example, the lubricant drain opening 56 can be closed, so that lubricant contained in the lubricant receiving volume 36 is prevented from flowing out of the lubricant receiving volume 36.

Since the lubricant receiving volume 36 is not completely filled with lubricant, the lubricant will accumulate in a lower region of the lubricant receiving volume 36, particularly when the soil processing machine 10 is at a standstill. If, for example, the lubricant is to be drained from the lubricant receiving volume 36 for replacement with fresh lubricant, the procedure can be such that the lubricant drain opening 56 is positioned in a lower position, relative to a height direction, preferably essentially directly below the roller axis of rotation W. The lubricant will then accumulate in a region of the lubricant receiving volume 36 that acts as a lubricant collecting volume 58 in this state. If the closing element is removed from the lubricant drain opening 56 in this state, the lubricant can flow out of the lubricant collecting volume 58 and in the process also carry out contaminants contained in the lubricant from the lubricant receiving volume 36.

In order to enable the lubricant to flow out as completely as possible from the lubricant receiving volume 36 or the region of the same which in this state acts as a lubricant collecting volume 58, the circumferential wall 32 is designed in such a way that it has a radial distance R from the roller axis of rotation W which increases in the direction of the roller axis of rotation W towards the support element 28 which has the lubricant drain opening 56. Advantageously, the circumferential wall 32 has an increasing radial distance R in its entire extension region between the two support elements 28, 30, wherein, relative to each axial region, the radial distance R can be constant in the circumferential direction, so that the circumferential wall 32 or the inner surface 34 of the same is essentially rotationally symmetrical with respect to the roller axis of rotation W and can, for example, have a frustoconical geometry. It should be noted that such a configuration refers to the circumferential wall 32 as a whole when the circumferential wall 32 is formed, for example, as a sheet metal part. For the purposes of the present invention, however, it is important that the variation of the radial distance R in the direction of the roller axis of rotation is present in particular on the inner surface 34 of the circumferential wall 32.

In FIG. 6 it can be seen that in the region in which the circumferential wall 32 adjoins the support element 28 having the lubricant drain opening 56, in the circumferential region of the lubricant drain opening, in particular in a circumferential region in which the center Z of the lubricant drain opening 56 lies, the inner surface 34 of the circumferential wall 32 has a radial distance D from the lubricant drain opening 56 and lies outside the lubricant drain opening 56. This means that in the transition from the inner surface 34 of the circumferential wall 32 to the lubricant drain opening 56, a step with a radial height corresponding to the distance D is formed. This ensures that the circumferential wall 32 can be connected to the support element 58 by means of a weld 60 formed on the inner side of the same. For reasons of stability, it can also be advantageous to provide such a weld 62 that runs completely around the roller axis of rotation B also on an outer side of the circumferential wall 32.

Providing the distance D between the lubricant drain opening 56 and the inner surface 34 of the circumferential wall 32 ensures that the weld 60 is not damaged when the lubricant drain opening 56 is introduced after the circumferential wall 32 has been connected to the support element 28.

Due to the design of the circumferential wall 32 with the radial distance R of the inner surface 34 increasing in the direction of the roller axis of rotation W, a dead volume T formed by the step corresponding to the distance D, from which the lubricant S cannot drain even when the lubricant drain opening 56 is open, is minimized. This dead volume T extends, starting from the support element 28, in the direction of the roller axis of rotation W only until the radial distance R between the inner surface 34 of the circumferential wall 32 and the roller axis of rotation W corresponds to the distance of the radially outermost region of the lubricant drain opening 56 to the roller axis of rotation W. The expansion of such a dead volume T over the entire axial length of the circumferential wall 32 is thus avoided. The result of this is that a significantly larger proportion of contaminants contained in the lubricant S can be discharged from the lubricant receiving volume 36 and, despite the step formed in the transition between the inner surface 34 and the support element 28 to the lubricant drain opening 56, only a comparatively small proportion of lubricant S remains in the lubricant receiving volume 36 or the lubricant collecting volume 58 used for the draining process.

It should be noted that such lubricant drain openings 56 can of course be provided in the support element 28 in several circumferential regions. Each of these lubricant drain openings 56 can then be used for draining lubricant from the lubricant receiving volume 36 during a draining process in conjunction with a respectively assigned volume region of the lubricant receiving volume 36 which is effective as a lubricant collecting volume 58.

An alternative embodiment of a soil processing roller 22 is shown in FIGS. 7 and 8. In this embodiment, too, a lubricant collecting volume 58 is formed in cooperation with a lubricant drain opening 56 provided on the support element 28 when the lubricant drain opening 56 is positioned at the bottom in the height direction, i.e. essentially vertically below the roller axis of rotation W, in which lubricant and impurities contained therein accumulate to a greater extent and can move towards the lubricant drain opening 56 when draining.

In the embodiment shown in FIGS. 7 and 8, the circumferential wall 32 or its inner surface 34 is essentially cylindrical and therefore has essentially the same cross-sectional geometry and cross-sectional area in all axial regions. The radial distance R of the inner surface 34 essentially does not vary in the axial direction with respect to the roller axis of rotation W. A variation of the radial distance R is provided in the circumferential direction around the roller axis of rotation W.

In the embodiment shown in FIGS. 7 and 8, the circumferential wall 32 or its inner surface 34 is divided into two circumferential extension regions U₁ and U₂ which are separated by dividing lines L₁ and L₂ or which merge into one another in these regions. In the first circumferential extension region U₁, which, as illustrated in FIG. 7, occupies the larger portion of the circumferential extension of the circumferential wall 32 or inner surface 34, the inner surface 34 has, in the circumferential direction, substantially a constant radial distance R from the roller axis of rotation W. In the second circumferential extension region U₂ the radial distance R increases substantially continuously up to a distance apex 64, starting from the respective adjacent region to the first circumferential extension region U₁. In the region of the distance apex 64, the inner surface 34 has its maximum radial distance R from the roller axis of rotation W. In the region of this spacing apex 64, the lubricant drain opening 56 is arranged radially within the circumferential wall 32. Here too, the lubricant drain opening 56 can have the positioning shown above with reference to FIG. 6 relative to the inner surface 34 of the circumferential wall 32, at a distance D, in particular when the circumferential wall 32 is connected, by means of the weld 60 extending on its inner side, to the support element 28.

By providing the spacing apex 64, in comparison to a circular configuration over the entire circumference of the circumferential wall 32 or the inner surface 34 of the same, when a draining process is carried out, the circumferential apex 64 and with it the lubricant drain opening 56 are arranged as far down as possible in the height direction, thus for example, directly under the roller axis of rotation W, the region in which the lubricant S contained in the lubricant receiving volume 36 and contaminants contained therein will accumulate, will be less extended in the circumferential direction. This applies in particular also to the dead volume created by providing the previously mentioned step. In comparison to the design of the inner surface 34 with a circular cross-sectional contour, this has a significantly smaller circumferential extent. When lubricant 56 is drained, a significantly smaller proportion of the lubricant and thus also a significantly smaller proportion of contaminants remains in the dead volume formed in this way, or it accumulates to a greater extent in the lubricant collecting volume 58 then formed in the region of the lubricant drain opening 56 when lubricant is drained, so that contaminants contained therein can be increasingly discharged from the lubricant receiving volume 36.

It should be noted that the embodiment described above with reference to FIGS. 7 and 8 can also be varied, for example, in such a way that there is a variation of the radial distance R essentially over the entire circumferential region of the inner surface 34. For example, in the region of a distance minimum 66 diametrically opposite the distance apex 64 with respect to the roller axis of rotation W, the inner surface 32 can have a minimum distance from the roller axis of rotation W, which can then increase substantially continuously in both circumferential directions towards the distance apex 64 and, for example, uniformly in both circumferential directions. This leads to a substantially teardrop-shaped cross-sectional contour of the inner surface 34, which can nevertheless be constant in the direction of the roller axis of rotation W, so that the cylindrical geometry of the inner surface 34 is again obtained.

A further modification of this embodiment is shown in FIG. 9. In this embodiment, the circumferential wall 32 or its inner surface 34 has a polygonal, here hexagonal, cross-sectional geometry. This means that there are a plurality of spacing apexes 64 distributed over the circumference. The radial distance R of the inner surface 34 to the roller axis of rotation W varies between two distance apexes 64 that are immediately adjacent in the circumferential direction. In the region of at least one of these apexes 64, a lubricant drain opening 56 is provided, so that when this spacing apex 64 with the lubricant drain opening 56 provided in association therewith is arranged as far down as possible in the height direction, for example vertically directly under the roller axis of rotation W, as illustrated in FIG. 9, the lubricant can accumulate in the lubricant collecting volume 58 formed in association with the lubricant drain opening 56 or in the region of the distance apex 64 and can flow out almost completely from the lubricant receiving volume 36.

A further variation of this design principle is shown in FIGS. 10 and 11. In this embodiment, the circumferential wall 32 or its inner surface 34 has a substantially constant radial distance R almost over the entire circumference around the roller axis of rotation W. In the circumferential region in which the lubricant drain opening 56 is provided in the support element 28, a step-like radial widening 68 is formed on the inner circumferential surface 34. In this embodiment too, the geometry of the inner surface 34 can be such that it is essentially constant, i.e. cylindrical, over the entire axial extent of the circumferential wall 32.

By providing the step-like radial widening 68, a lubricant collecting region 58 is formed in the circumferential region in which the lubricant drain opening 56 is provided in the support element 28 when a draining process is carried out, in which lubricant and contaminants accumulate increasingly and in particular at the end of a draining process on a limited comparatively small circumferential region so that even if the dead volume explained above with reference to FIG. 6 is created, the amount of lubricant still remaining in the lubricant collecting volume 58 is comparatively small.

Finally, it should be noted that design aspects explained above with reference to the figures can of course be combined with one another. Thus, the circumferential wall on its inner surface could have a radial distance from the roller axis of rotation that varies both in the axial direction and in the circumferential direction and increases in the direction of a region in which a lubricant drain opening is provided in a support element. The particularly advantageous effect of the present invention with the increased accumulation of lubricant or contaminants in a circumferential region or an axial region in which a lubricant drain opening is provided can also be used if the lubricant drain opening radially directly contacts the inner surface of the circumferential wall. This can be the case, for example, if the provision of a weld on the inner side of the circumferential wall is not necessary and a sufficiently stable connection that in particular ensures a tight seal can be achieved by the weld provided on the outer side. The creation of a dead volume can be completely avoided.

In principle, as FIG. 11 also suggests, the lubricant drain opening could be arranged to overlap radially with the circumferential wall, for example by introducing the lubricant drain opening into the support element by drilling after connecting the circumferential wall to the support element. Such a hole can then be formed in an axial region of the circumferential wall, so that, limited to this axial region of the circumferential wall, through the hole also encompassing the circumferential wall, the step-like, in this case rounded, radial widening of the inner surface of the circumferential wall described above with reference to FIG. 11, can be achieved. In this region too, when draining lubricant from the lubricant receiving volume, particularly at the end of a draining process, the lubricant present in the lubricant collecting volume can be essentially completely drained from the lubricant receiving volume, so that almost no residue remains in the lubricant receiving volume.

1. A soil processing roller for a soil processing machine, in particular a soil compactor, comprising a roller shell which is elongated in the direction of a roller axis of rotation and surrounds the roller axis of rotation, two disk-like support elements arranged at a distance from one another in the direction of the roller axis of rotation and connected to an inner side of the roller shell, and a circumferential wall extending in the direction of the roller axis of rotation between the support elements and adjoining the same, wherein an inner surface of the circumferential wall together with the support elements delimits a lubricant receiving volume, wherein, in at least one of the support elements, at least one lubricant drain opening is provided, which is open to the lubricant receiving volume, wherein at least one lubricant collecting volume is formed in the lubricant receiving volume, wherein the at least one lubricant collecting volume is emptiable via a lubricant drain opening that is open to the same,
wherein, to provide the lubricant collecting volume:
the inner surface of the circumferential wall has a radial distance from the roller axis of rotation that increases in the direction of the roller axis of rotation towards the lubricant drain opening which is open to the at least one lubricant collecting volume,
and/or
the inner surface of the circumferential wall has a radial distance from the roller axis of rotation that increases in the circumferential direction around the roller axis of rotation to the lubricant drain opening which is open to the at least one lubricant collecting volume.

2. The soil processing roller of claim 1,
wherein, when designing the inner surface of the circumferential wall with a radial distance from the roller axis of rotation which increases in the direction of the roller axis of rotation to the lubricant drain opening open to the at least one lubricant collecting volume, the inner surface of the circumferential wall is optionally rotationally symmetrical with respect to the roller axis of rotation, at least in the axial region of the lubricant collecting volume.

3. The soil processing roller of claim 2,
wherein the inner surface of the circumferential wall is essentially rotationally symmetrical over the entire axial extension region of the circumferential wall.

4. The soil processing roller of claim 1,
wherein, when designing the inner surface of the circumferential wall with a radial distance from the roller axis of rotation which increases in the direction of the roller axis of rotation to the lubricant drain opening open to the at least one lubricant collecting volume, the radial distance increases substantially in a constant manner in the direction of the roller axis of rotation.

5. The soil processing roller of claim 1,
wherein, when designing the inner surface of the circumferential wall with a radial distance from the roller axis of rotation which increases in the circumferential direction around the roller axis of rotation to the lubricant drain opening open to the at least one lubricant collecting volume, the inner surface of the circumferential wall is essentially cylindrical at least in the axial region of the lubricant collecting volume.

6. The soil processing roller of claim 5,
wherein the inner surface of the circumferential wall is essentially cylindrical over the entire axial extension region of the circumferential wall.

7. The soil processing roller of claim 1,
wherein, when designing the inner surface of the circumferential wall with a radial distance to the roller axis of rotation increasing in the circumferential direction around the roller axis of rotation toward the lubricant drain opening open to the at least one lubricant collecting volume, the inner surface of the circumferential wall has a polygonal cross-sectional contour at least in the axial region of the lubricant collecting volume, wherein at least a part of the at least one lubricant collecting volume is formed in a corner region of the polygonal cross-sectional contour.

8. The soil processing roller of claim 1,
wherein when designing the inner surface of the circumferential wall with a radial distance to the roller axis of rotation increasing in the circumferential direction around the roller axis of rotation toward the lubricant drain opening open to the at least one lubricant collecting volume, the inner surface of the circumferential wall has a cross-sectional contour at least in the axial region of the lubricant collecting volume with a substantially constant radial distance from the roller axis of rotation in a first circumferential extension region and has, in a second circumferential extension region adjoining the first circumferential extension region in both circumferential directions up to a distance apex, wherein at least a part of the at least one lubricant collecting volume is formed in the region of the distance apex.

9. The soil processing roller of claim 1,
wherein, when designing the inner surface of the circumferential wall with a radial distance to the roller axis of rotation increasing in the circumferential direction around the roller axis of rotation toward the lubricant drain opening open to the at least one lubricant collecting volume, the inner surface of the circumferential wall has, at least in the axial region of the lubricant collecting volume, a cross-sectional contour with, starting from a minimum distance, in both directions to a distance apex, wherein at least a part of the at least one lubricant collecting volume is formed in the region of the distance apex.

10. The soil processing roller of claim 9,
wherein the distance minimum is essentially diametrically opposite the distance apex with respect to the roller axis of rotation.

11. The soil processing roller of claim 1,
wherein, when designing the inner surface of the circumferential wall with a radial distance to the roller axis of rotation increasing in the circumferential direction around the roller axis of rotation toward the lubricant drain opening open to the at least one lubricant collecting volume, the inner surface of the circumferential wall has a step-like radial widening at least in the axial region of the lubricant collecting volume for providing at least a part of the at least one lubricant collecting volume.

12. The soil processing roller of claim 1,
wherein at least one support element having at least one lubricant drain opening is connected to the circumferential wall by a weld which runs in the circumferential direction around the roller axis of rotation.

13. The soil processing roller of claim 12,
wherein the weld is formed at least on a radial inner side of the circumferential wall, and in that the inner surface of the circumferential wall in the region of the at least one lubricant drain opening is arranged radially outside of the at least one lubricant drain opening and has a radial distance from the lubricant drain opening.

14. The soil processing roller of claim 1,
wherein an unbalance arrangement with at least one unbalance mass rotatable about an unbalance axis of rotation is arranged in the lubricant receiving volume.

15. The soil processing roller of claim 14,
wherein the at least one unbalance mass is arranged on an unbalance shaft which is rotatably mounted in both axial end regions via bearing arrangements with respect to the support elements.

16. A soil processing machine, in particular a soil compactor, comprising at least one soil processing roller of claim 1.
